(19) United States
(12) Patent Application Publication
(10) Pub. No.: US 2004/0145776 A1
(43) Pub. Date: Jul. 29, 2004

(54) Digital multiple function processing machine and printer

(76) Inventor: Osamu Azami, Nagano (JP)

Correspondence Address: Jonathan P. Osha, Rosenthal & Osha L.L.P., Suite 2800, 1221 McKinney St., Houston, TX, 77010, US

(21) Appl. No.: 10/722,347

(22) Filed: Nov. 25, 2003

(30) Foreign Application Priority Data
Nov. 28, 2002 (JP) P. 2002-346068

(51) Int. Cl. G06F 15/00; H04N 1/00

(52) U.S. Cl. 358/1.15; 358/401

(57) ABSTRACT

A digital multiple function processing machine is made up of a scanner, a copy operation unit, and a printer. When the user enters an interrupt copy start command through the copy operation unit, a wait is made until an available storage area required for executing the interrupt copy is provided in the printer before the scanner is started.

The present application is based on Japanese Patent Application No. 2002-346068, which is incorporated herein by reference.

### BACKGROUND OF THE INVENTION

1. Field of the Invention

This invention relates to a digital multiple function processing machine having a printer function and a copier function and a printer that can be used as a component of such a digital multiple function processing machine.

2. Description of the Related Art

As is generally known, some digital multiple function processing machines each having printer and copier functions can start a copy job during printing, which will be hereinafter referred to as “make an interrupt copy.” (For example, refer to patent document 1.)

[Patent document 1]

Unexamined Japanese Patent Publication No. Hei-10-233864

Hitherto, various machines different in specific hardware configuration, function, or operation method have been developed as already existing digital multiple function processing machines having the functions as mentioned above. However, when a command for starting an interrupt copy is given, every existing digital multiple function processing machine performs processing according to the following procedure:

Upon reception of a command for starting an interrupt copy, the digital multiple function processing machine starts processing of generating image data representing the image on the original whose copy is to be made and storing the image data in memory (processing of generating image data concerning the original using a scanner and storing the image data in memory) and also starts processing of monitoring to see if the print processing being executed (processing for actually drawing on paper) enters an interruptable state. When the print processing being executed enters an interruptable state, the digital multiple function processing machine interrupts the print processing being executed and starts print processing based on the image data stored in the memory.

To sum up, at the interrupt copy time, every existing digital multiple function processing machine performs processing involving a procedure requiring available memory of a large capacity (processing in which interrupt copy frequently terminates incompletely because of insufficient memory unless large-capacity memory is installed).

### SUMMARY OF THE INVENTION

It is an object of the invention to provide a digital multiple function processing machine for making it possible to make an interrupt copy, having a configuration that can be implemented without installing large-capacity memory.

It is another object of the invention to provide a printer that can be used as a component of the digital multiple function processing machine of the invention.

To the ends, according to the invention, there is provided a digital multiple function processing machine including an image data supply unit, an operation unit, and a printer, wherein the image data supply unit can execute image data transmission processing of generating and transmitting image data representing an image on an original set on the image data supply unit, wherein the operation unit enables the user to perform interrupt copy start command operation and when the user performs the interrupt copy start command operation, transmits interrupt copy start command information, and wherein the printer can also be connected to a computer having a function of transmitting print job data and includes print execution means for forming an image on paper based on print data in a predetermined format; print data storage means for temporarily storing print data to be processed by the print execution means; reception means for receiving print job data representing printed matter of several pages from the connected computer; print job data processing means for generating from the print job data received by the reception means, the print data concerning the printed matter represented by the print job data for each page and storing the print data in the print data storage means; and copy control means capable of executing copy control processing of causing the image data supply unit to start the image data transmission processing, storing print data responsive to image data transmitted by the image data supply unit as the result of the image data transmission processing in the print data storage means, and causing the print execution means to print based on the print data, if the interrupt copy start command information is received while the print job data processing means operates, the copy control means for causing the print job data processing means to interrupt the processing being executed and then starting processing of waiting for an available storage area of a capacity required for executing the copy control processing to be formed in the data storage means, when an available storage area of the capacity required for executing the copy control processing is formed, the copy control means for causing the print execution means to interrupt processing for the print data generated by the print job data processing means and then starting the copy control processing.

That is, in the digital multiple function processing machine of the invention, the image data supply unit for converting an original into digital data is started when the user gives an interrupt copy start command (when the user performs interrupt copy command operation for the operation unit). Therefore, the digital multiple function processing machine of the invention is an apparatus of a smaller memory capacity required for manufacturing than that of an already existing digital multiple function processing machine wherein the operation of scanner is started when the user gives an interrupt copy start command (the digital multiple function processing machine is an apparatus that can be implemented without installing large-capacity memory).

To realize the digital multiple function processing machine of the invention, the operation unit may enable the user to perform operation made up of print interrupt command operation and copy start command operation as the interrupt copy start command operation and when the user performs the print interrupt command operation, may transmit print interrupt command information as element information of the interrupt copy start command information and when the user performs the copy start command operation, may transmit copy start command information as element information of the interrupt copy start command information, and when the print interrupt command information is received while the print job data processing means operates, the copy control means of the printer may cause the print job data processing means to interrupt the processing being executed, when the copy start command information is received after the print interrupt command information is received, the copy control means may start processing of waiting for an available storage area of the capacity required for executing the copy control processing to be formed in the data storage means, and when an available storage area of the capacity required for executing the copy control processing is formed, the copy control means may cause the print execution means to interrupt processing for the print data generated by the print job data processing means and then starts the copy control processing.

To realize the digital multiple function processing machine of the invention as an apparatus that can make various types of copies (copies different in original size, resolution, etc.,), preferably the operation unit enables the user to set a copy condition and transmits information containing copy condition information representing the copy condition set by the user as the interrupt copy start command information, and the copy control means of the printer calculates the capacity of an available storage area required for executing the copy control processing based on the copy condition information contained in the interrupt start command information.

According to the invention, there is provided a printer that can be connected to an image data supply unit that can execute image data transmission processing of generating and transmitting image data representing an image on an original set on the image data supply unit and a computer that can transmit print job data, the printer including print execution means for forming an image on paper based on print data in a predetermined format; print data storage means for temporarily storing print data to be processed by the print execution means; reception means for receiving print job data representing printed matter of several pages from the connected computer; print job data processing means for generating from the print job data received by the reception means, the print data concerning the printed matter represented by the print job data for each page and storing the print data in the print data storage means; and copy control means capable of executing copy control processing of causing the image data supply unit to start the image data transmission processing, storing print data responsive to image data transmitted by the image data supply unit as the result of the image data transmission processing in the print data storage means, and causing the print execution means to print based on the print data, if the interrupt copy start command information is received while the print job data processing means operates, the copy control means for causing the print job data processing means to interrupt the processing being executed and then starting processing of waiting for an available storage area of a capacity required for executing the copy control processing to be formed in the data storage means, when an available storage area of the capacity required for executing the copy control processing is formed, the copy control means for causing the print execution means to interrupt processing for the print data generated by the print job data processing means and then starting the copy control processing. Therefore, if the printer of the invention is combined with the image data supply unit, etc., the digital multiple function processing machine of the invention can be realized.

### BRIEF DESCRIPTION OF THE DRAWINGS

In the accompanying drawings:

In the accompanying drawings:

FIG. 1A is a block diagram of a digital multiple function processing machine according to an embodiment of the invention and FIG. 1B is a drawing to show the appearance of the digital multiple function processing machine;

FIG. 2A is a block diagram of a copy operation unit used with the digital multiple function processing machine according to the embodiment of the invention and FIG. 2B is a schematic representation of the copy operation unit;

FIG. 3 is a block diagram of a printer used with the digital multiple function processing machine according to the embodiment of the invention;

FIG. 4 is a flowchart to show the general operation procedure of the copy operation unit;

FIGS. 5A and 5B are schematic representations of a copy basic screen displayed by the copy operation unit;

FIGS. 6A and 6B are schematic representations of a copy executing screen displayed by the copy operation unit;

FIG. 7 is a schematic representation of a print stop wait screen displayed by the copy operation unit;

FIG. 8 is a schematic representation of an insufficient memory notification screen displayed by the copy operation unit; and

FIG. 9 is a flowchart to show the general operation procedure of the printer.

### DETAILED DESCRIPTION OF THE PREFERRED EMBODIMENTS

Referring now to the accompanying drawings, there is shown a preferred embodiment of the invention.

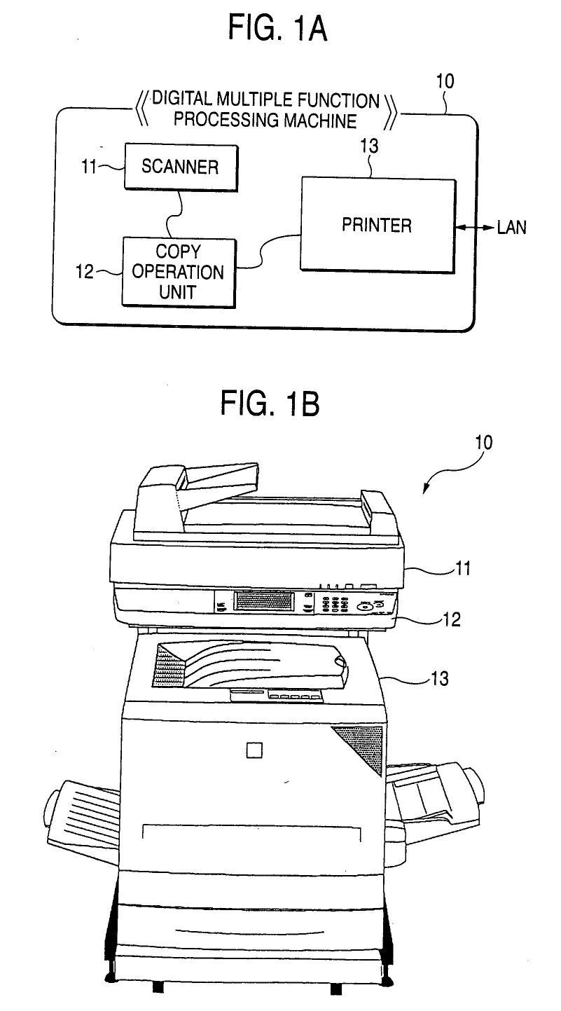

As shown in FIGS. 1A and 1B, a digital multiple function processing machine 10 according to one embodiment of the invention is an apparatus (system) which has an appearance similar to that of a general copier, a general digital multiple function processing machine, etc., and is made up of a scanner 11, a printer 13, and a copy operation unit 12 connected thereto. The digital multiple function processing machine 10 has the printer 13 connected to a LAN (Local Area Network) for operation.

The scanner 11 used with the digital multiple function processing machine 10 is a machine for reading an image on an original set thereon and generating image data representing the read image. The scanner 11 has a hardware configuration and function similar to those of a general scanner.

The copy operation unit 12 is a unit for causing the digital multiple function processing machine 10 to function as a copier.

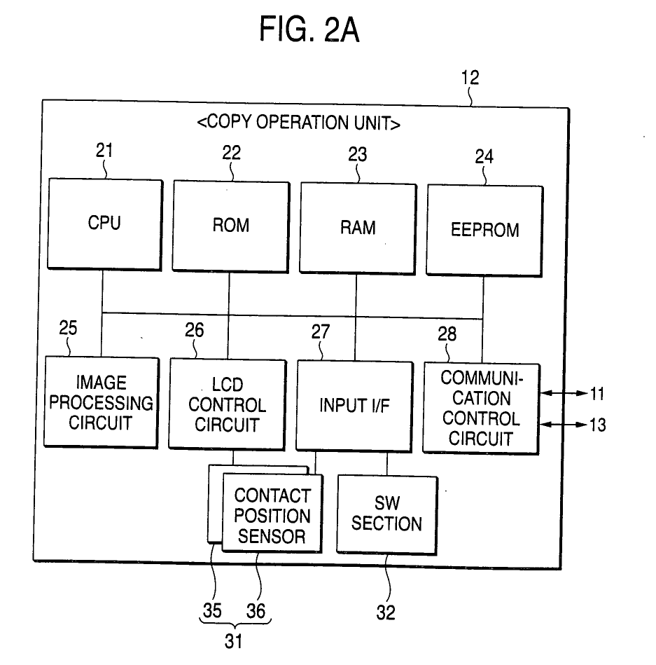

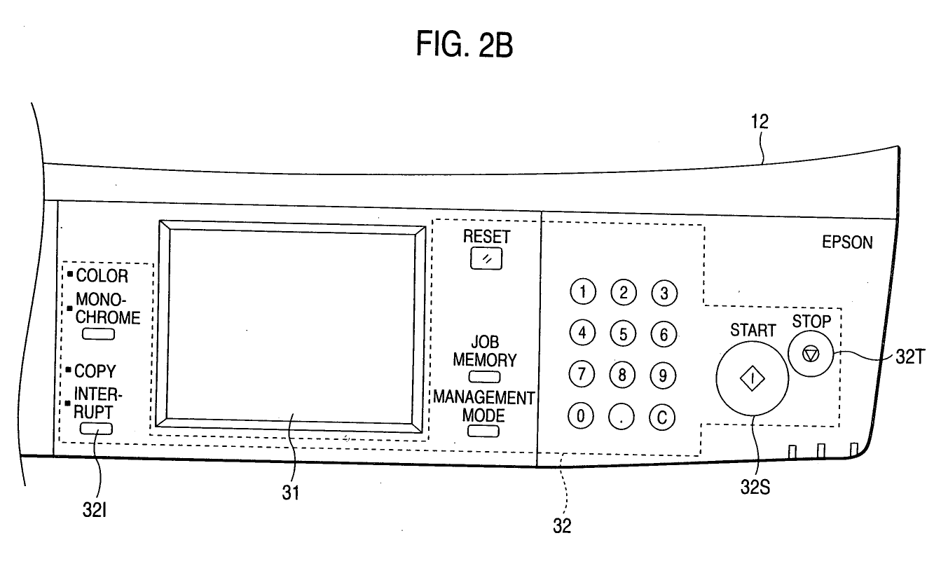

The copy operation unit 12 is made up of a CPU 21, ROM 22, RAM 23, EEPROM 24, an image processing circuit 25, an LCD control circuit 26, an input interface circuit (input I/F) 27, a communication control circuit 28, a touch screen 31 (device having a transparent contact position sensor 36 superposed on a liquid crystal display (LCD) 35), a switch section (SW section) 32, etc., as shown in FIG. 2A. The switch section 32 is a unit made up of various pushbutton switches such as an interrupt switch 32I, a start switch 32S, a stop switch 32T, and a ten-key numeric pad provided on the top of the copy operation unit 12, as shown in FIG. 2B.

The CPU 21, forming a part of the copy operation unit 12 is a control circuit for integrally controlling the components of the digital multiple function processing machine 10 (the components in the copy operation unit 12, the scanner 11, and the printer 13). The ROM 22 is nonvolatile memory storing various programs for defining operation procedures of the CUP 21 and various pieces of data used by the CPU 21. The RAM 23 is memory for temporarily storing various pieces of information. The EEPROM 24 is rewritable nonvolatile memory for storing information for defining operation conditions when the copy operation unit 12 is started and the like.

The image processing circuit 25 is a circuit capable of generating data provided by performing various types of image processing such as moire removal and edge enhancement for image data generated by the scanner 11 and then undergoing simple processing in the printer 13 at the printing time based on that data (data in the same format as data internally provided by the printer 13 receiving print job data, which will be hereinafter also referred to as print data).

The LCD control circuit 26 is a circuit for displaying an image (screen) as specified by the CPU 21 on the LCD 35. The input interface circuit 27 is a circuit for sending operator's operation of the switch section 32 or the contact position sensor 36 to the CPU 21. The communication control circuit 28 is a circuit used for the copy operation unit 12 (CPU 21) to exchange information with the scanner 11 and the printer 13 (transfer data and a command to and from the scanner 11 and the printer 13).

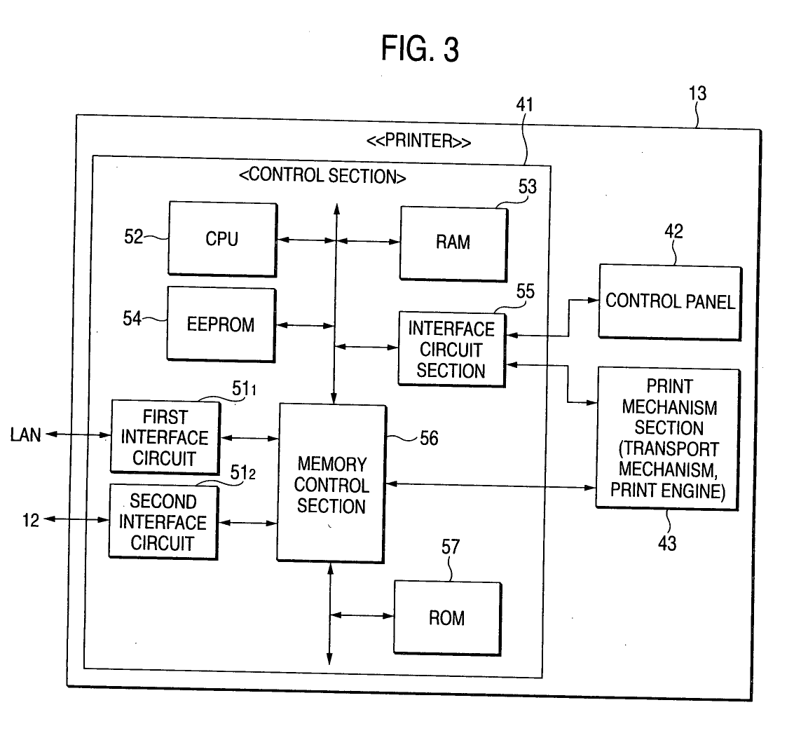

On the other hand, the printer 13 used with the digital multiple function processing machine 10 includes a control section 41, a control panel 42, and a print mechanism section 43, as shown in FIG. 3.

The control panel 42 of the printer 13 provides an interface between the user and the printer 13 (control section 41). The control panel 42 is made up of a plurality of pushbutton switches that can be pressed by the user, a plurality of LEDs for indicating the operation state of the printer 13, a liquid crystal display for displaying various messages, and the like.

The print mechanism section 43 prints (forms) an image on paper under the control of the control section 41. The print mechanism section 43 is made up of a print engine for actually forming an image on paper (in the embodiment, print engine capable of color printing), a transport mechanism for supplying paper to the print engine and ejecting printed paper to the outside of the printer 13 (mechanism made up of a paper feeder, a paper ejection unit, etc.,), and the like.

When the user performs significant operation on the control panel 42 or information in a predetermined format is received from an external machine (a computer on the LAN or the copy operation unit 12), the control section 41 performs control processing in response to the performed operation or the received information. As shown in the figure, the control section 41 of the printer 13 is a unit made up of a first interface circuit 511, a second interface circuit 512, a CPU 52, RAM 53, EEPROM 54, an input interface circuit section 55, a memory control section 56, ROM 57, etc.

Of the components, the first interface circuit 511 is a circuit for communicating with the computer on the LAN (mainly, receiving print job data). The second interface circuit 512 is a circuit for communicating with the copy operation unit 12. The CPU 52 is a control circuit for integrally controlling the components in the control section 41. The ROM 57 is nonvolatile memory storing various programs executed by the CPU 52 and font data used by the CPU 52 (program).

The RAM 53 is memory used as a work area by the CPU 52 (program executed by the CPU 52). The memory control section 56 is a circuit for performing processing of passing information received at the first interface circuit 511 or the second interface circuit 512 to the CPU 52, processing of transferring information received at the first interface circuit 511 or the second interface circuit 512 to the RAM 53, processing of supplying a signal responsive to print data in the RAM 53 (data provided from the received print job data, data transmitted from the copy operation unit 12) to the print engine in the print mechanism section 43, and the like. The input interface circuit section 55 is a circuit used for the CPU 52 to control the components of the control panel 42 and the print mechanism section 43. The input interface circuit section 55 is made up of several interface circuits for transferring data between the CPU 52 and the control panel 42, data between the CPU 52 and the transport mechanism in the print mechanism section 43, and the like.

If the user presses the interrupt switch 32I even while the printer 13 is printing based on print job data transmitted by the computer on the LAN, the digital multiple function processing machine 10 interrupts the print operation of the printer 13 and can be used as a copier (apparatus for ejecting a copy of the original set on the scanner 11 from the printer 13 if the user presses the start button 32S). At the termination of the copy processing started as the user presses the start switch 32S after pressing the interrupt switch 32I, the digital multiple function processing machine 10 does not restart the interrupted print operation and when the user again presses the start switch 32S or when a predetermined time has elapsed without performing any user's operation, restarts the interrupted print operation.

Predicated on the description given above, the operation of the digital multiple function processing machine 10 according to the embodiment will be specifically discussed below:

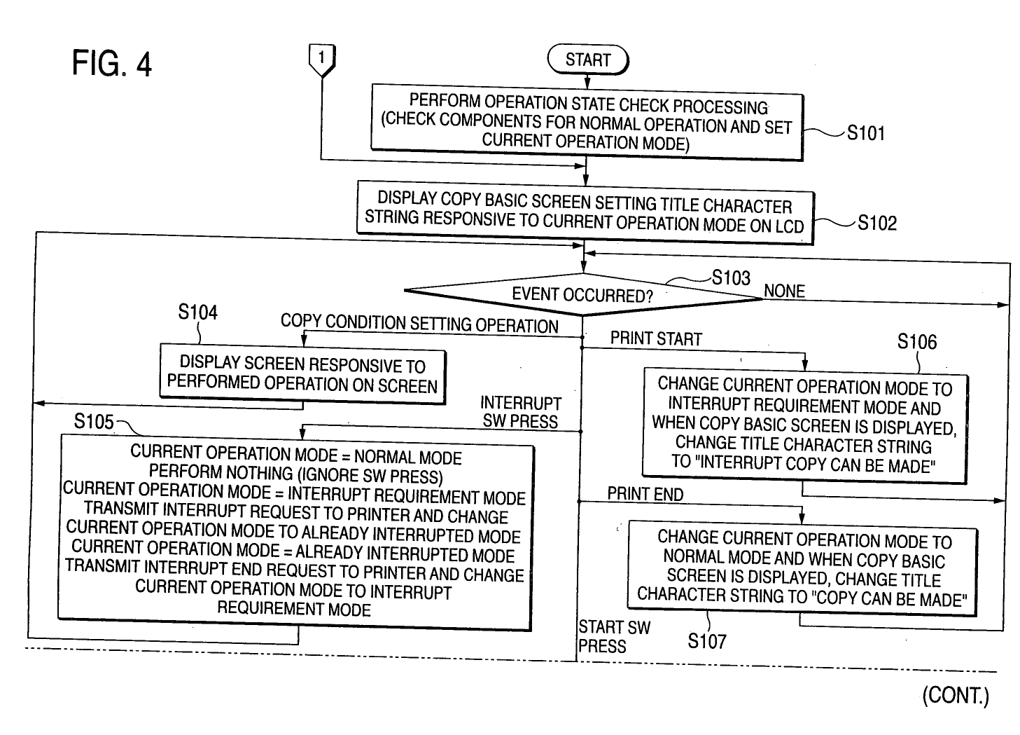

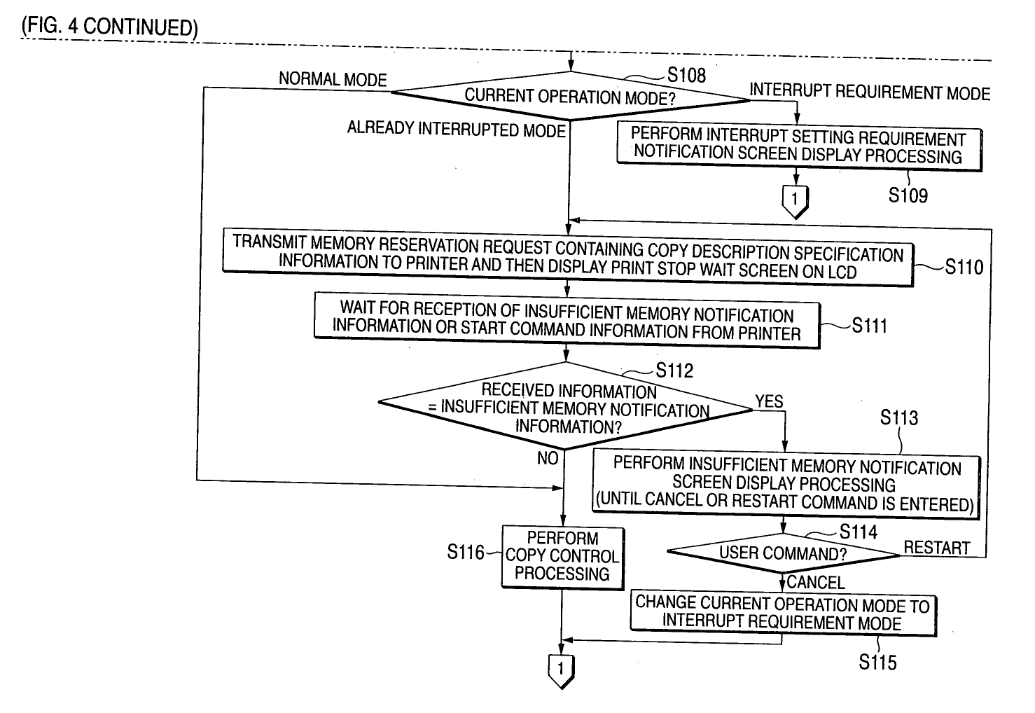

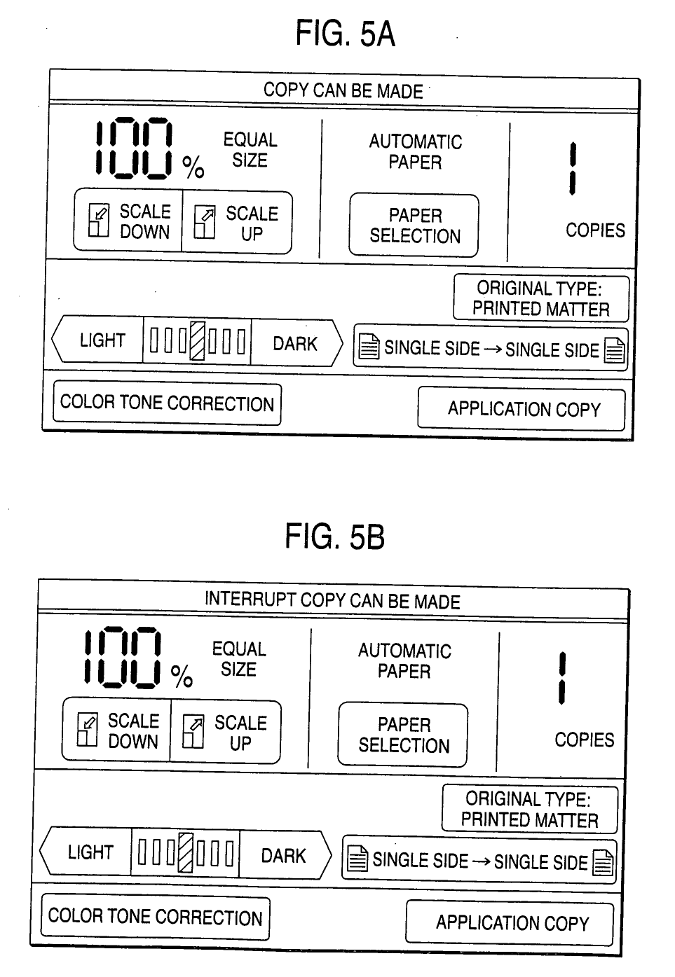

To begin with, the operation of the copy operation unit 12 will be discussed with FIGS. 4 to 8. FIG. 4 is a flowchart to show the general operation procedure of the CPU 21 in the copy operation unit 12. FIGS. 5 to 8 are schematic representations of screens which may be displayed on the LCD 35 (touch screen 31) during the operation of the copy operation unit 12.

As shown in FIG. 4, the started copy operation unit 12 first performs operation state check processing for checking that the scanner 11, the printer 13, and the copy operation unit 12 function normally (step S101). At this time, the copy operation unit 12 also performs processing of checking to see if the printer 13 is printing (processing of transmitting a predetermined status request (command) to the printer 13 and then acquiring returned status information representing the operation state of the printer 13 from the printer 13). If the printer 13 is not printing, the copy operation unit 12 stores information indicating that the current operation mode is a normal mode (sets a value representing the normal mode in a current operation mode variable). On the other hand, if the printer 13 is printing, the copy operation unit 12 stores information indicating that the current operation mode is an interrupt requirement mode.

Upon completion of the operation state check processing, the copy operation unit 12 performs processing of displaying a copy basic screen setting a title character string responsive to the current operation mode on the LCD 35 (step S102). The copy basic screen is a screen as shown in FIG. 5A or 5B. The title character string is a character string such as “COPY CAN BE MADE” or “INTERRUPT COPY CAN BE MADE” displayed on the top of the copy basic screen shown in FIG. 3A or 3B. The character string “COPY CAN BE MADE” is the title character string set in the copy basic screen if the current operation mode is the normal mode.

Displaying the copy basic screen on the LCD 35, the copy operation unit 12 starts processing of waiting for an event to occur (step S103 in FIG. 4). Specifically, at step S103, the copy operation unit 12 performs processing of monitoring effective operation performed on the contact position sensor 36 or the switch section 32 while periodically performing processing of acquiring status information from the printer 13.

If the copy operation unit 12 detects the user performing copy condition setting operation (different operation from pressing the start switch 32S or the interrupt switch 32I) (copy condition setting operation at step 103), the copy operation unit 12 goes to step S104 and displays the screen responsive to the performed operation on the LCD 35. That is, at step S104, the copy operation unit 12 displays a screen different from the copy basic screen on the LCD 35, again displays the copy basic screen on the LCD 35, and updates the contents of the screen being displayed. Then, the copy operation unit 12 returns to step S103 and again waits for an event to occur.

If the copy operation unit 12 detects the printer 13 starting print (print start at step S103), the copy operation unit 12 goes to step S106 and changes the current operation mode to the interrupt requirement mode. If the copy basic screen is displayed on the LCD 35, the copy operation unit 12 also changes the title character string to “INTERRUPT COPY CAN BE MADE.” Then, the copy operation unit 12 again executes step S103.

If the copy operation unit 12 detects the printer 13 terminating print (print end at step S103), the copy operation unit 12 goes to step S107 and changes the current operation mode to the normal mode. If the copy basic screen is displayed on the LCD 35, the copy operation unit 12 changes the title character string to “COPY CAN BE MADE.” Then, the copy operation unit 12 again executes step S103.

If the copy operation unit 12 detects the user pressing the interrupt switch 32I (interrupt SW press at step S103), the copy operation unit 12 goes to step S105 and performs the following processing:

First, the copy operation unit 12 determines which of the normal mode, the interrupt requirement mode, and an already interrupted mode the current operation mode is. If the current operation mode is the normal mode, the copy operation unit 12 performs no operation and returns to step S103. If the current operation mode is the interrupt requirement mode, the copy operation unit 12 transmits an interrupt request to the printer 13 and changes the current operation mode to the already interrupted mode and then returns to step S103. If the current operation mode is the already interrupted mode, the copy operation unit 12 transmits an interrupt end request to the printer 13 and changes the current operation mode to the interrupt requirement mode and then returns to step S103.

Then, the copy operation unit 12 executes step S103.

If the copy operation unit 12 detects the user pressing the start switch 32S (start SW press at step S103), the copy operation unit 12 also determines which of the normal mode, the interrupt requirement mode, and the already interrupted mode the current operation mode is (step S108).

If the current operation mode is the normal mode (normal mode at step S108), the copy operation unit 12 goes to step S116 and performs copy control processing of controlling the scanner 11 and the printer 13 so as to make a copy under the current copy conditions (copy conditions set by the user operating the copy basic screen).

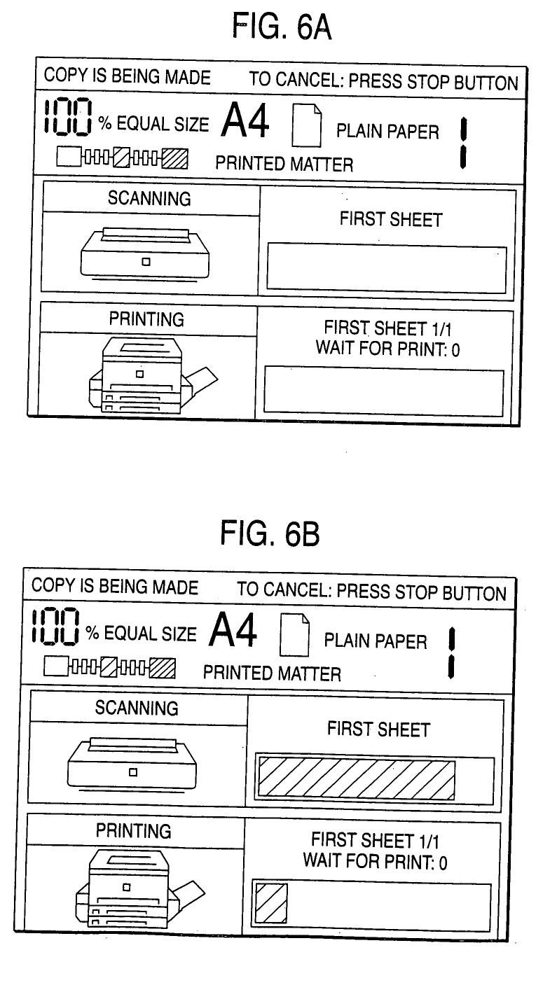

Specifically, when performing the copy control processing, the copy operation unit 12 first displays a copy executing screen as shown in FIG. 6A on the LCD 35. Next, the copy operation unit 12 performs processing for causing the scanner 11 to start the original read operation responsive to the current copy conditions. That is, the copy operation unit 12 transmits commands for specifying the operation conditions (image read conditions) responsive to the current copy conditions and a command for starting the original read operation to the scanner 11. Next, the copy operation unit 12 transmits commands for specifying the operation conditions (print conditions) responsive to the current copy conditions to the printer 13. The copy operation unit 12 starts processing of generating image data (print data) subjected to image processing responsive to the current copy conditions from image data transmitted by the scanner 11 starting the original read operation and supplying the print data to the printer 13 (namely, processing of using the image processing circuit 25 to convert the image data from the scanner 11 into print data and transmitting the print data to the printer 13, which will be hereinafter referred to as image data supply processing). While executing the image data supply processing, the copy operation unit 12 also changes the contents of the copy executing screen displayed on the LCD 35 to those as shown in FIG. 6B (representing the current progress state of the copying).

At the termination of the image data supply processing, the copy operation unit 12 determines whether or not the original whose copy is to be made remains in the scanner 11 (ADF in the scanner 11). If the original whose copy is to be made remains in the scanner 11, the copy operation unit 12 performs processing of causing the scanner 11 to start the original read operation of another original (transmitting various commands to the scanner 11) and then again starts image data supply processing. On the other hand, if the original whose copy is to be made does not remain in the scanner 11, the copy operation unit 12 continues only the processing of changing the display contents of the copy executing screen and upon completion of copying (printing) of the printer 13, terminates the copy control processing.

The copy operation unit 12 terminating the copy control processing again executes the processing starting at step S102.

If the user presses the start switch 32S when the current operation mode is the normal mode, the copy operation unit 12 performs the processing as described above. The printer 13 prints based on the data as the copy control processing is performed, which will be hereinafter referred to as copy job data (described below in detail). That is, when the current operation mode is the normal mode, the digital multiple function processing machine 10 functions as an apparatus for starting copy processing immediately when the user presses the start switch 32S.

In contrast, if the user presses the start switch 32S when the current operation mode is the interrupt requirement mode (start SW press at step S103, interrupt requirement mode at step S108), the copy operation unit 12 performs interrupt setting requirement notification screen display processing for notifying the user that a copy cannot be made unless the current printing is interrupted because the printer 13 is printing at present (step S109). Specifically, when performing the interrupt setting requirement notification screen display processing, the copy operation unit 12 first displays an interrupt setting requirement notification screen displaying a message indicating the state on the LCD 35. Then, the copy operation unit 12 waits for the user to perform acknowledgement operation (in the embodiment, press an OK button displayed in the interrupt setting requirement notification screen). When the user performs the acknowledgement operation, the copy operation unit 12 restores the display contents of the LCD 35 to the same contents as those when the user pressed the start button 32S and then terminates the interrupt setting requirement notification screen display processing. The copy operation unit 12 terminating the interrupt setting requirement notification screen display processing executes the processing starting at step S102.

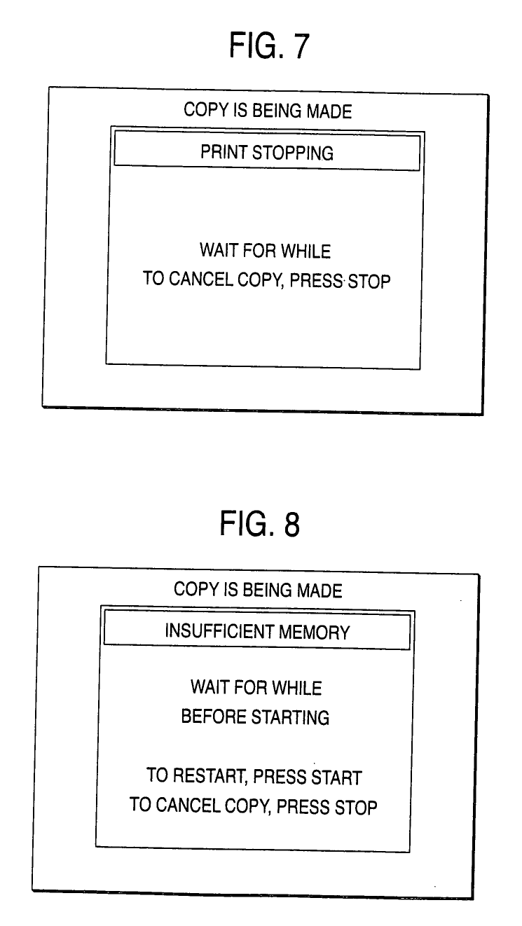

If the user presses the start switch 32S when the current operation mode is the already interrupted mode (start SW press at step S103, already interrupted mode at step S108), the copy operation unit 12 transmits a memory reservation request containing copy description specification information to the printer 13 and then displays a print stop wait screen on the LCD 35 (step S110). The print stop wait screen is a screen for notifying the user that copy start processing (processing for causing the printer 13 to interrupt print) is being performed, as shown in FIG. 7. The copy description specification information is information based on which the control section 41 in the printer 13 can calculate the memory capacity required for performing processing to make a copy of the original whose interrupt copy is to be made. In the digital multiple function processing machine 10, information provided by excluding unnecessary commands for calculating the memory capacity, such as a paper ejection unit specification command, from the commands transmitted to the printer 13 at the copy control processing time is used as the copy description specification information.

The copy operation unit 12 terminating the processing at step S110 (FIG. 4) starts processing of waiting for insufficient memory notification information or start command information transmitted from the printer 13 (step S111).

When start command information is transmitted from the printer 13 (NO at step S112), the copy operation unit 12 goes to step S116 and performs the copy control processing previously described and then executes the processing starting at step S102.

On the other hand, when insufficient memory notification information is transmitted from the printer 13 (YES at step S112), the copy operation unit 12 goes to step S113 and performs insufficient memory notification screen display processing of displaying an insufficient memory notification screen as shown in FIG. 8 on the LCD 35 and waiting for the user to enter a command by pressing the start switch 32S or the stop switch 32T.

When the user gives a restart command (restart at step S114), the copy operation unit 12 executes the processing starting at step S110. When the user gives a processing cancel command, namely, presses the stop switch 32T (cancel at step S114), the copy operation unit 12 changes the current operation mode to the interrupt requirement mode (step S115) and then executes the processing starting at step S102.

Although not shown in the flowchart, when the print stop wait screen is displayed on the LCD 35 (step S111 is being executed), if the user presses the stop switch 32T, the copy operation unit 12 transmits an interrupt end request to the printer 13 and changes the current operation mode to the interrupt requirement mode. Then, the copy operation unit 12 executes the processing starting at step S102.

Next, the operation of the printer 13 is as follows:

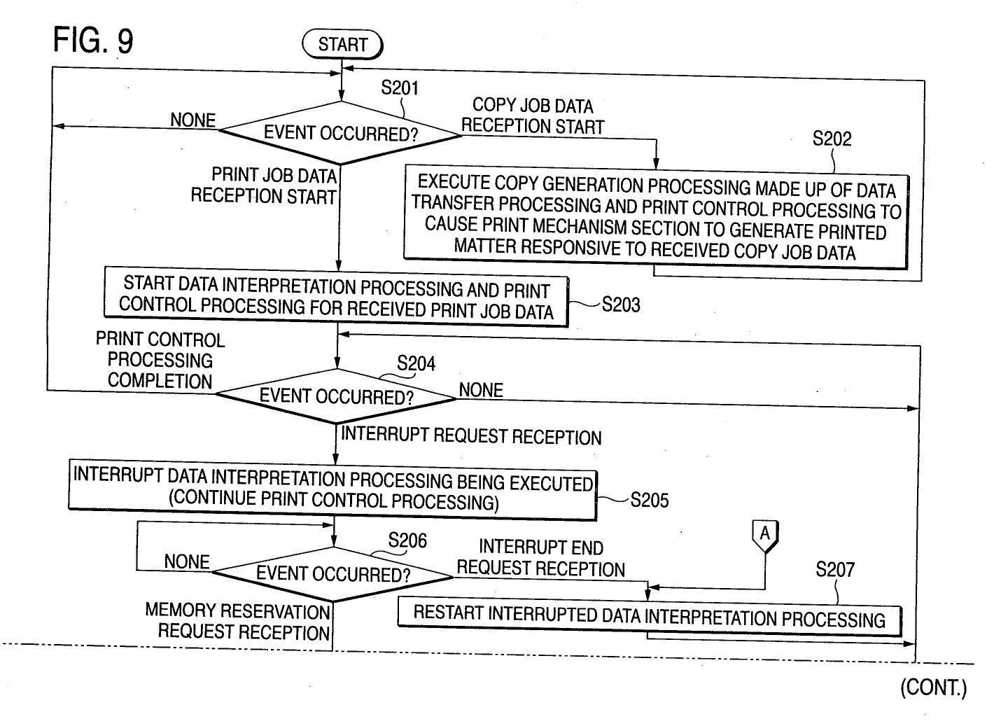

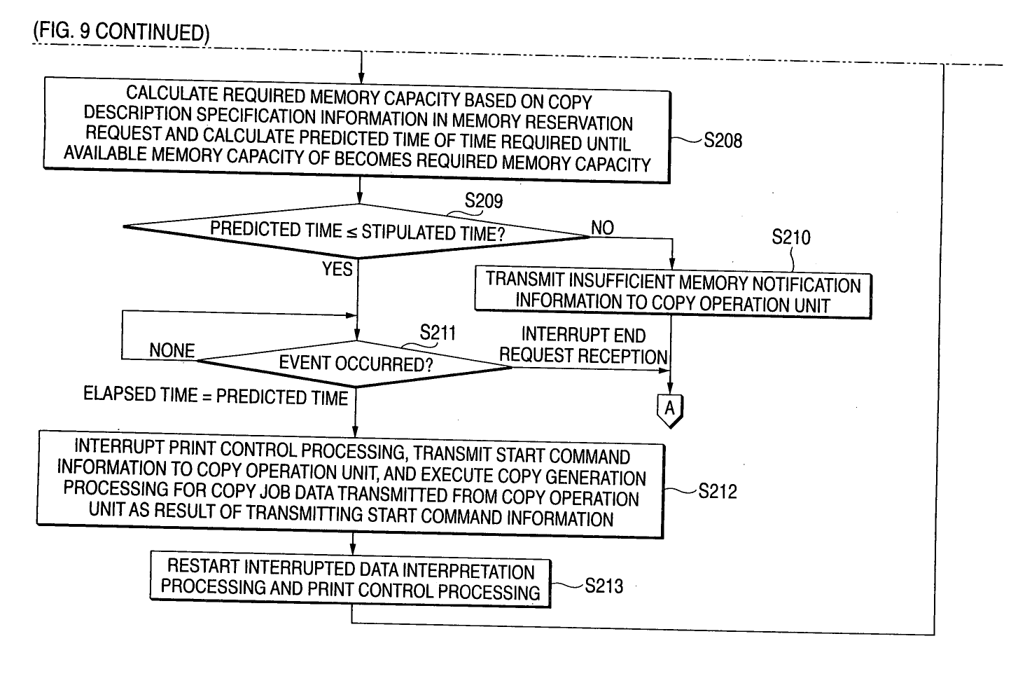

When power of the printer 13 is turned on, the control section 41 in the printer 13 performs initialization processing of checking the components of the printer 13 for normal function and initializing the components and then enters a state in which the control section 41 responds to a status request and also executes processing shown in FIG. 9.

That is, the control section 41 terminating the initialization processing starts processing of monitoring reception of copy job data and reception of print job data (step S201).

If reception of copy job data is started (copy job data reception start at step S201), the control section 41 goes to step S202 and performs processing of concurrently executing processing of storing print data sent as an element of the copy job data in the RAM 53 and print control processing of causing the print mechanism section 43 to print in response to the print data stored in the RAM 53, which will be hereinafter referred to as copy generation processing.

At step S202, the control section 41 also performs processing to place the control section 41 in a state in which it does not accept reception of print job data during execution of the copy generation processing (places the first interface circuit 51₁ in a busy state during execution of the copy generation processing).

On the other hand, if reception of print job data is started (print job data reception start at step S201), the control section 41 goes to step S203 and starts data interpretation processing and print control processing for the print job data. The data interpretation processing is processing of interpreting each drawing command in the received print job data and generating the print data responsive to the print job data in the RAM 53. The print control processing is processing of causing the print mechanism section 43 to print based on the print data generated in the RAM 53 as the data interpretation processing is performed (the same processing as processing performed for the print data sent as an element of the copy job data when the copy generation processing is performed).

Then, the control section 41 goes to step S204 and monitors occurrence of an event of termination of the print control processing or reception of an interrupt request while executing the data interpretation processing and the print control processing (only the print control processing after completion of the data interpretation processing). Although not shown in the flowchart for the sake of simplicity, at step S204, the control section 41 also monitors reception of a memory reservation request (transmitted by the copy operation unit 12 when the user gives a restart command). When the control section 41 detects reception of a memory reservation request, it executes step S205 described later and then executes step S208 and later described later.

When the print control processing is complete (print control processing completion at step S204), the control section 41 returns to step S201 and starts processing of monitoring reception of copy job data and reception of print job data.

On the other hand, if an interrupt request is received before the print control processing is complete (interrupt request reception at step S204), the control section 41 goes to step S205 and performs processing to interrupt the data interpretation processing being executed. Then, the control section 41 goes to step S206 and monitors occurrence of an event of reception of an interrupt end request or reception of a memory reservation request while executing the print control processing. If the control section 41 is not executing the data interpretation processing (is executing only the print control processing), the control section 41 skips step S205. The interrupt end request whose reception is monitored by the control section 41 at step S206 is an interrupt end request transmitted by the copy operation unit 12 when the user presses the interrupt switch 32I to terminate the interrupt copy (presses the interrupt switch 32I at the second time).

If an interrupt end request is received after the interrupt request is received (interrupt end request reception at step S206), the control section 41 goes to step S207 and performs processing to restart the interrupted data interpretation processing and then starts the processing at step S204. When monitoring reception of an interrupt end request, although not shown in the flowchart, the control section 41 also monitors an event that a predetermined time (time that can be set by the user, stored in the EEPROM 54) has elapsed without receiving any information from the copy operation unit 12, which will be hereinafter referred to as timeout event. When detecting occurrence of a timeout event, the control section 41 performs the same processing as that when the interrupt end request is received.

On the other hand, if a memory reservation request is received after the interrupt request is received (memory reservation request reception at step S206), the control section 41 goes to step S208 and first calculates the required memory capacity for executing copy generation processing for the original whose interrupt copy is to be made by the user based on the copy description specification information contained in the memory reservation request. Next, the control section 41 calculates the predicted time of the time required until the available capacity of the RAM 53 first exceeds the calculated required memory capacity as the print data in the RAM 53 is processed as the print control processing is performed, based on the print job data to which the print control processing is applied (paper size, resolution, presence or absence of multiple copy print) (step S208).

Then, if the predicted time exceeds the stipulated time (NO at step S209), the control section 41 transmits insufficient memory notification information to the copy operation unit 12 (step S210). The stipulated time is information stored in a specific area of the EEPROM 54. The printer 13 enables the user to set (change) the stipulated information by operating the control panel 42 (or transmitting a predetermined command from the computer to the printer 13).

The control section 41 terminating the processing at step S210 goes to step S207 and restarts the interrupted data interpretation processing and then starts the processing at step S204.

On the other hand, if the predicted time is equal to or less than the stipulated time (YES at step S209), the control section 41 goes to step S211 and monitors occurrence of an event that the elapsed time since the execution time of step S208 matches the predicted time at step S208 or an event of reception of an interrupt end request.

If an interrupt end request is received before the elapsed time since the execution time of step S208 matches the predicted time at step S208 (interrupt end request reception at step S211), the control section 41 executes processing starting at step S207. The interrupt end request whose reception is monitored at step S211 is an interrupt end request transmitted by the copy operation unit 12 as the user presses the stop switch 32T when the print stop wait screen is displayed on the LCD 35.

If the elapsed time since the execution time of step S208 matches the predicted time at step S208 without reception of an interrupt end request (elapsed time=predicted time at step S211), the control section 41 goes to step S212 and transmits start command information to the copy operation unit 12 and then performs copy generation processing for copy job data transmitted from the copy operation unit 12 as the result of transmitting the start command information.

The control section 41 terminating the processing at step S212 goes to step S213 and performs processing to restart the interrupted data interpretation processing and print control processing (only print control processing if the data interpretation processing is complete) and then returns to step S204 and again waits for termination of print control processing or reception of an interrupt request or a memory reservation request.

Last, the reason why the processing starting at step S208 is performed after step S205 is executed when reception of a memory reservation request is detected will be discussed briefly.

The control section 41 transmitting the insufficient memory notification information to the copy operation unit 12 (step S210 in FIG. 9) starts operation in the same state as an interrupt request is not yet received although print job data is being processed (operation in a state in which data interpretation processing is not interrupted). On the other hand, the copy operation unit 12 receiving the insufficient memory notification information performs the processing starting at step S113 (FIG. 4) and thus if the user seeing the insufficient memory notification screen (FIG. 8) displayed on the LCD 35 gives a restart command, the control section 41 receives the memory reservation request at step S204 in a state in which the control section 41 executes data interpretation processing and print control processing. Thus, upon reception of the memory reservation request at step S204, the control section 41 performs the processing starting at step S208 after executing step S205.

As described above in detail, in the digital multiple function processing machine 10 according to the embodiment, the scanner 11 is started when the user gives an interrupt copy start command (when the user presses the start switch 32S of the copy operation unit 21 after pressing the interrupt switch 32I). Therefore, the digital multiple function processing machine 10 is an apparatus of a smaller memory capacity required for manufacturing than that of an already existing digital multiple function processing machine wherein the operation of scanner 11 is started when the user gives an interrupt copy start command (the digital multiple function processing machine 10 is an apparatus that can be implemented without installing large-capacity memory).

<Modifications>

Various modifications of the digital multiple function processing machine 10 descried above can be made. For example, the digital multiple function processing machine 10 is an apparatus having the scanner 11 and the printer 13 connected through the copy operation unit 12; however, the digital multiple function processing machine 10 may be modified to an apparatus (system) made up of a scanner and a copy operation unit and a printer connected to the scanner and the copy operation unit wherein a user command given to the copy operation unit is sent through the printer to the scanner.

As the processing at steps S208 to S211 in FIG. 9, the printer 13 may be configured so as to perform the following processing: Available memory capacity is monitored periodically and if the available memory capacity becomes equal to or greater than the required memory capacity before the elapsed time after processing started exceeds the stipulated time, start command information is transmitted to the copy operation unit 12; if the elapsed time after processing started exceeds the stipulated time before the available memory capacity becomes equal to or greater than the required memory capacity, insufficient memory notification information is transmitted to the copy operation unit 12. The printer 13 operating in such a manner can be manufactured simply by changing the already existing program for the printer 13, so that the printer 13 having the configuration is also an apparatus that can be manufactured easier than the above-described printer 13.

Further, the printer 13 may be modified so as to transmit start command information to the copy operation unit 12 when the elapsed time reaches “predicted time-“time until completion of transmission of one-page image data after copy operation unit 12 receives start command information”” or when the elapsed time reaches “predicted time-“time until starting of transmission of image data after copy operation unit 12 receives start command information”” rather than to transmit start command information to the copy operation unit 12 when the elapsed time becomes the predicted time (the available storage area of the RAM 53 becomes equivalent to the required memory capacity).

The digital multiple function processing machine 10 may be modified so that the printer 13 is assigned a function of outputting the available memory capacity and the copy operation unit 12 determines whether or not the available memory capacity in the printer 13 becomes the necessary amount for executing copy control processing. The digital multiple function processing machine 10 may be modified so that a switch having the functions of the interrupt switch 32I and the start switch 32S is provided on the copy operation unit 12 and when a request transmitted if the user presses the switch is received, the printer recognizes the request as an interrupt request and a memory reservation request.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. A digital multiple function processing machine comprising an image data supply unit, an operation unit, and a printer, wherein
said image data supply unit can execute image data transmission processing of generating and transmitting image data representing an image on an original set on said image data supply unit,
said operation unit enables a user to perform interrupt copy start command operation and when the user performs the interrupt copy start command operation, transmits interrupt copy start command information, and
said printer can be connected to a computer having a function of transmitting print job data and comprises:
print execution means for forming an image on paper based on print data in a predetermined format;
print data storage means for temporarily storing print data to be processed by the print execution means;
reception means for receiving print job data representing printed matter of several pages from the connected computer;
print job data processing means for generating from the print job data received by the reception means, the print data concerning the printed matter represented by the print job data for each page and storing the print data in the print data storage means; and
copy control means capable of executing copy control processing of causing said image data supply unit to start the image data transmission processing, storing print data responsive to image data transmitted by said image data supply unit as the result of the image data transmission processing in the print data storage means, and causing the print execution means to print based on the print data, if the interrupt copy start command information is received while the print job data processing means operates, the copy control means for causing the print job data processing means to interrupt the processing being executed and then starting processing of waiting for an available storage area of a capacity required for executing the copy control processing to be formed in the data storage means, when an available storage area of the capacity required for executing the copy control processing is formed, the copy control means for causing the print execution means to interrupt processing for the print data generated by the print job data processing means and then starting the copy control processing.

2. A digital multiple function processing machine according to claim 1, wherein said operation unit enables the user to perform operation made up of print interrupt command operation and copy start command operation as the interrupt copy start command operation and when the user performs the print interrupt command operation, transmits print interrupt command information as element information of the interrupt copy start command information and when the user performs the copy start command operation, transmits copy start command information as element information of the interrupt copy start command information, and wherein
when the print interrupt command information is received while the print job data processing means operates, the copy control means of said printer causes the print job data processing means to interrupt the processing being executed, when the copy start command information is received after the print interrupt command information is received, the copy control means starts processing of waiting for an available storage area of the capacity required for executing the copy control processing to be formed in the data storage means, and when an available storage area of the capacity required for executing the copy control processing is formed, the copy control means causes the print execution means to interrupt processing for the print data generated by the print job data processing means and then starts the copy control processing.

3. A digital multiple function processing machine according to claim 1, wherein said operation unit enables the user to set a copy condition and transmits information containing copy condition information representing the copy condition set by the user as the interrupt copy start command information, and wherein
the copy control means of said printer calculates the capacity of an available storage area required for executing the copy control processing based on the copy condition information contained in the interrupt start command information.

4. A printer that can be connected to an image data supply unit that can execute image data transmission processing of generating and transmitting image data representing an image on an original set on the image data supply unit and a computer that can transmit print job data, said printer comprising:
print execution means for forming an image on paper based on print data in a predetermined format;
print data storage means for temporarily storing print data to be processed by the print execution means;
reception means for receiving print job data representing printed matter of several pages from the connected computer;
print job data processing means for generating from the print job data received by the reception means, the print data concerning the printed matter represented by the print job data for each page and storing the print data in the print data storage means; and
copy control means capable of executing copy control processing of causing the image data supply unit to start the image data transmission processing, storing print data responsive to image data transmitted by the image data supply unit as the result of the image data transmission processing in the print data storage means, and causing the print execution means to print based on the print data, if the interrupt copy start command information is received while the print job data processing means operates, the copy control means for causing the print job data processing means to interrupt the processing being executed and then starting processing of waiting for an available storage area of a capacity required for executing the copy control processing to be formed in the data storage means, when an available storage area of the capacity required for executing the copy control processing is formed, the copy control means for causing the print execution means to interrupt processing for the print data generated by the print job data processing means and then starting the copy control processing.

5. A printer according to claim 4, wherein the interrupt copy start command information is information made up of print interrupt command information and copy start command information, and wherein
when the print interrupt command information is received while the print job data processing means operates, the copy control means causes the print job data processing means to interrupt the processing being executed, when the copy start command information is received after the print interrupt command information is received, the copy control means starts processing of waiting for an available storage area of the capacity required for executing the copy control processing to be formed in the data storage means, and when an available storage area of the capacity required for executing the copy control processing is formed, the copy control means causes the print execution means to interrupt processing for the print data generated by the print job data processing means and then starts the copy control processing.

6. A printer according to claim 4, wherein the interrupt start command information is information containing copy condition information representing a copy condition, and wherein
the copy control means calculates the capacity of an available storage area required for executing the copy control processing based on the copy condition information contained in the interrupt start command information.
